(19) United States
(12) Patent Application Publication
(10) Pub. No.: US 2005/0151653 A1
(43) Pub. Date: Jul. 14, 2005

(54) Method and apparatus for determining the occurrence of animal incidence

(76) Inventors: Wee Piak Chan, Singapore (SG); Fook Sing Kuan, Singapore (SG); Wai Chuen Kok, Singapore (SG)

Correspondence Address: Stephen M. De Klerk;BLAKELY, SOKOLOFF, TAYLOR & ZAFMAN LLP, Seventh Floor, 12400 Wilshire Boulevard, Los Angeles, CA, 90025, US

(21) Appl. No.: 10/897,481

(22) Filed: Jul. 23, 2004

(30) Foreign Application Priority Data
Jul. 25, 2003 (SG) 200304002-9

(51) Int. Cl. G08B 23/00

(52) U.S. Cl. 340/573.2; 340/539.1; 43/58

(57) ABSTRACT

There is provided a trap for trapping animals including: at least one radio frequency (RF) device closely associated with the trap for the recording of activation data of the trap, at least one animal containment unit incorporated with the trap, and at least one sensor for detecting activation of the trap and passing an activation signal to the RF device. Preferably, the RF device is for transmitting RF signals to at least one receiving unit for enabling the real-time determination of a status of the trap.

### FIELD OF INVENTION

This invention relates to a method and apparatus for determining the status of animal traps used for trapping animals (including insects) or detecting and monitoring their activities. The method and apparatus is particularly relevant for, though not exclusively so, small animals such as, for example, rats, mice, possums, hedgehogs, groundhogs, ferrets, squirrels, chipmunks, rabbits, cats, dogs, reptiles such as snakes and lizards, birds such as crows and magpies, and insects such as cockroaches, termites, spiders, and mosquitoes.

### BACKGROUND

There are currently several categories of animal traps in use throughout the world. One category of trap simply captures the animal without harming it; while another category of trap kills the animal. Such traps generally meet their objective of capturing, or capturing and killing, the animal. Such traps are usually employed where the use of poison is prohibited. However, the user of such traps cannot ascertain whether the trap has been activated without an on-site observation of each trap. This practice is inefficient in the time taken and the man-power required.

There are also bait stations which do not trap any animals but merely count the number of visitations to the station. Unfortunately, the user of such stations cannot ascertain the incidence of visitations without physically counting the number of baits being consumed on site. This practice is also inefficient and time consuming. Such bait stations are useful as they do not impart negative experiences to the animals which would cause their fellow creatures to avoid the stations.

The complexity and inconvenience of conducting such checks becomes more obvious when such traps are deployed by the hundreds in varied locations, such as, for example, in multi-storey buildings, shopping malls and large expanses of land including forests, trees, bushes and so forth. The task becomes even more complicated when the traps are deployed in the ventilation and sewerage systems of the buildings and other areas where ease of accessibility to people is quite limited.

Health and hygiene issues also arise when such traps contain the trapped animals. There will be more adverse effects when the trapped animals are dead. If not cleared regularly, dead animals may decompose, thus attracting flies, cockroaches, ants and other parasites. The situation of parasites, maggots and germs emanating from such decomposing carcasses poses an extremely undesirable situation. This is especially so when the trap is placed in the ventilation system of buildings. Such traps should be cleared in a short time after it has been used to prevent the transmission of these parasites and germs to the tenants in the building.

The instance whereby an animal is trapped but not killed must be attended to in a short time or the animal may die of hunger or thirst. This becomes extremely crucial if the trapped animal belongs to an endangered group of animals.

### SUMMARY OF INVENTION

In order to provide a method and apparatus for determining the occurance of animal incidence, there is provided a trap for trapping animals including: at least one radio frequency (RF) device closely associated with the trap for the recording of activation data of the trap, at least one animal containment unit incorporated with the trap, and at least one sensor for detecting activation of the trap and passing an activation signal to the RF device. Preferably, the RF device is for transmitting signals to at least one receiving unit for enabling the real-time determination of a status of the trap.

Preferably, the RF device includes: at least one power source, at least one RF transceiver, non-volatile memory, at least one microcontroller, and at least one re-setting means to erase information stored in the non-volatile memory.

Advantageously, the receiving unit may either be mobile or fixed. Preferably, the mobile receiving unit includes: at least one power source, at least one display panel, at least one RF transceiver, non-volatile memory, at least one microcontroller, at least one control panel to control the collection and transmittal of data relating to the status of the at least one trap, at least one telecommunications transmitter to transmit information to a central station, and at least one synchronisation port to enable the downloading of information to the central station.

Similarly, the fixed receiving unit includes: at least one power source, at least one RF transceiver, non-volatile memory, at least one microcontroller, and at least one telecommunications transmitter to transmit information to a central station. The fixed receiving unit may be located at a particular location.

Advantageously, the fixed and mobile receiving unit may transmit RF signals after interacting with a mobile receiving unit which subsequently displays the status and location of activated traps by comparing with pre-programmed data in the mobile receiving unit.

It is also advantageous that the mobile and fixed receiving unit can be connected to the central station to download data via a wireless telecommunication transmission. The mobile receiving unit may be connected to the central station to download data via a synchronisation port.

Preferably, the fixed receiving unit may be connected to the central station to download data either via a wireless or a wired telecommunication transmission. When multiple fixed receiving units are deployed, the data may be relayed from one fixed receiving unit to the next by wired or wireless means before the last fixed receiving units may be connected to the central station to download data either via a wireless or a wired telecommunication transmission.

Preferably, the transmission range of the RF signals lies between 0-100 m. It would be more ideal that the range of transmission of the RF signals lies between 5-70 m. It would be most ideal that the range of transmission of the RF signals is 50 m.

It is advantageous that the trap requires the keying in of a Personal Identification Number (PIN) into the mobile receiving unit to be operable.

There is also provided a method for determining the status of at least one trap for animals at a regular time interval. Preferably, the regular time interval is two days and the status of at least one trap includes the occurance of animal incidence.

Advantageously, the trap is used to determine the occurance of animal incidence. It is also preferable that the status of the trap includes the occurance of animal incidence.

Preferably, the RF signals may be transmitted intermittently, continuously, or only after interaction with the receiving unit. It is also preferable that the localised area can be chosen from a group consisting of: a building, a cluster of buildings, a plot of land less than one hectare.

### DESCRIPTION OF DRAWINGS

In order that the invention may be better understood and readily put into practical effect, there shall now be described by way of non-limitative example only preferred embodiments of the present invention, the description being in reference to the accompanying illustrative drawings in which:

FIG. 1 shows a representation of a trap employed in the present invention.

FIG. 2 shows the schematic representation of the Radio Frequency (RF) device incorporated in a trap;

FIG. 3 shows the schematic representation of both the fixed receiving unit and the mobile RF receiving unit;

FIG. 4 shows the schematic flow of the status of the trap(s) to the central station;

FIG. 5 shows the sequence of steps in the method of finding out the status of a trap;

FIG. 6 shows examples of the types of traps employable with the present invention; and

FIG. 7 shows a possible appearance of the mobile receiving unit used in the present invention.

### DESCRIPTION OF PREFERRED EMBODIMENTS

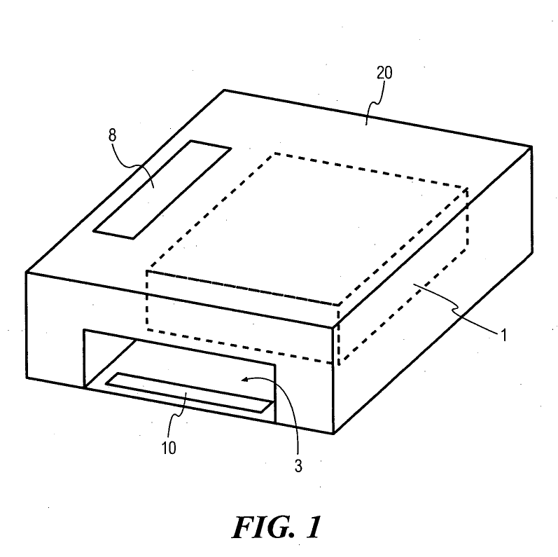

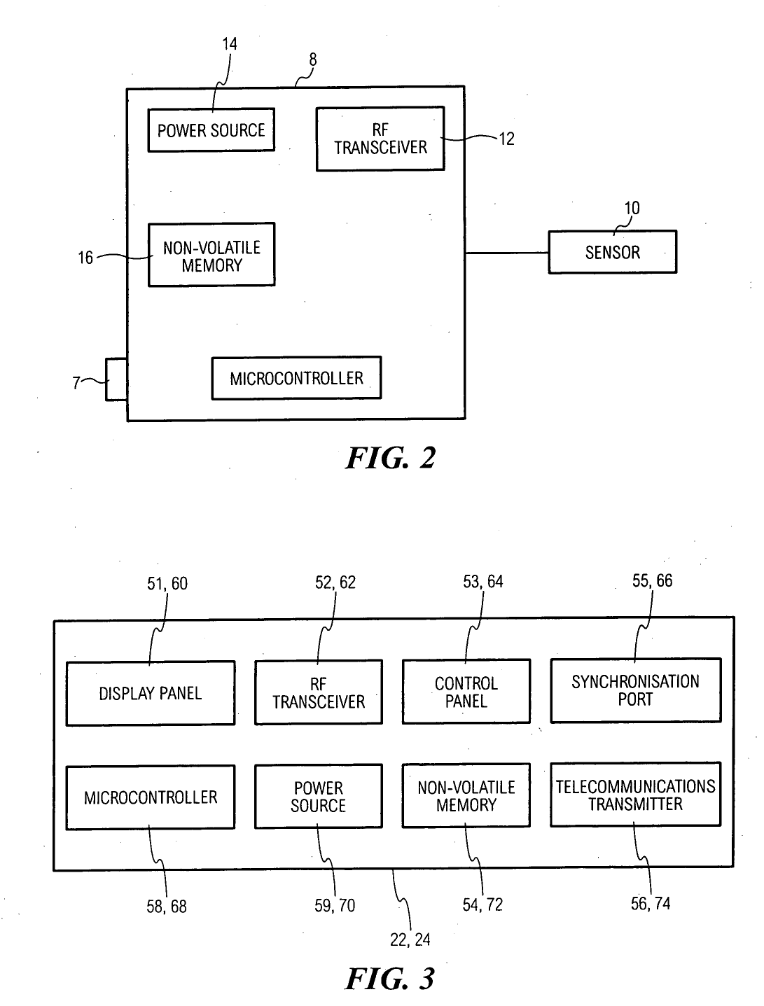

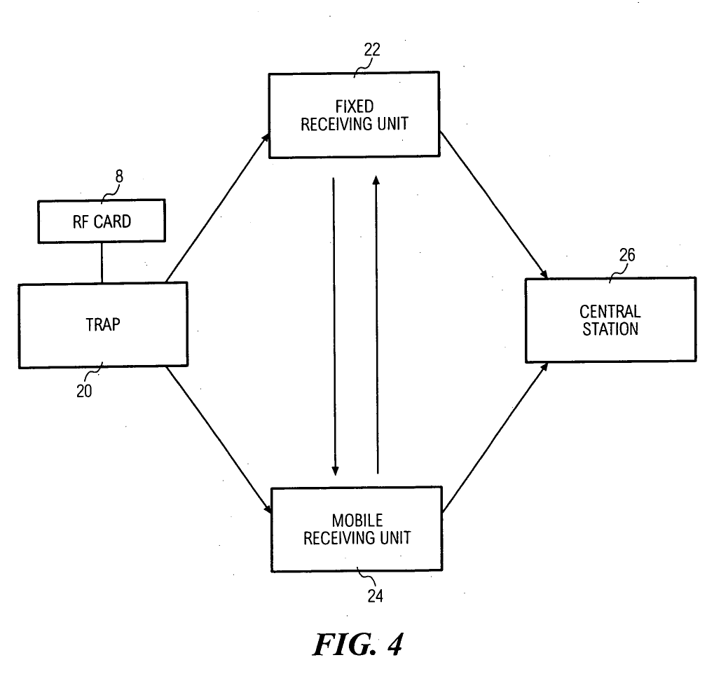

FIGS. 1 and 4 show a preferred embodiment of the present invention. FIG. 1 shows a trap 20 for small animals either used for rodent population control or for determining the occurance of animal incidence. The trap 20 includes a RF device 8 as shown in FIG. 2. The RF device 8 includes a power source 14, an RF transceiver 12, non-volatile memory 16, a microcontroller 9, and a re-set button 7. The trap 20 may have a power source (not shown) that may be powered by an electricity supply, solar energy or an independent power supply such as a battery. The power source 14 may be an internally or externally mounted battery. The trap 20 may be used in a similar role as a bait station, except that no baits are used and the counting is done by the incidences of the activation of a sensor 10. This renders the trap to be usable in areas where the use of bait may be prohibited, such as in the chemical and pharmaceutical industries.

The non-volatile memory 16 may be used to store information relating to the details of when the trap 20 was activated and may be cleared when the re-set button 7 is pressed. The re-set button 7 may be pressed when an animal containment unit 1 is cleared. The microcontroller 9 may be used to control the operation of the trap 20. As shown in FIG. 2, the sensor 10 may be closely associated with the RF device 8. The sensor 10 may be used to determine the presence of animals/insects going into the trap 20. The sensor 10 may be a mechanical or electronic device or a combination of both. The sensor 10 may be positioned at the entrance of the trap 20 or may also be positioned anywhere on the base floor 3 of the trap 20.

When the sensor 10 is activated, the microcontroller 9 may control the RF transceiver 12 to transmit RF signals that “inform” all receivers of the RF signals that the trap 20 has been activated. The RF transceiver 12 may also transmit RF signals after interaction with a mobile receiving unit 24. The RF signals may be continuously transmitted or may be transmitted only after being “awoken” through interaction with a mobile receiving unit 24. The latter method is uses energy more efficiently.

The trap 20 may be placed either indoors or outdoors. The positioning of the trap 20 may be determined by the behaviourial patterns of the animal/insect being sought. The traps 20 may be placed in a building. The traps 20 may be placed in exposed positions such as in rooms and corridors, or they may be concealed in locations such as, for example, ventilation and lift shafts, sewers, implanted around the foundational structure of the building and the like.

The RF device 8 closely associated with the trap 20 has at least one RF transceiver unit 12 for the transmission of RF signals to either a fixed receiving unit 22 or a mobile receiving unit 24. The RF transceiver 12 transmits RF signals once an animal triggers a sensor 10 in trap 20 after receiving a command from the microcontroller 9. The RF signal may include an identity (ID) of the trap 20. The RF signal may also include date/time stamping of when the trap 20 was activated and may also include the number of counts that the sensor 10 is activated. This facility may aid in projects whereby counting a population of animals/insects in a particular location may be required. The trap 20 may consist of at least one animal containment unit 1 for the trapped rodent or its carcass. The transmitted signals from the RF device 8 of the trap 20 may be recorded as trap-status information pertaining to each trap 20 in a non-volatile memory 54 of the fixed receiving unit 22 or recorded in a non-volatile memory 72 of the mobile receiving unit 24. The RF device 8 may also transmit signals only after being “awoken” through interaction with the mobile receiving unit 24. This step may save energy consumption by the RF device 8 by not continuously transmitting RF signals. The transmitted RF signals may also be transmitted intermittently.

A schematic diagram of the fixed receiving unit 22 is shown in FIG. 3. It may include a RF transceiver 52, non-volatile memory 54, a telecommunications transmitter 56, a microcontroller 58 and a power source 59. The fixed receiving unit may also have a display panel 51, a control panel 53 and a synchronisation port 55. The fixed receiving unit 22 may have a power source 59 that may be powered by a wired electricity supply, solar energy or an independent power supply such as a battery. The RF transceiver 52 may receive RF signals sent from the trap 20. The fixed receiving unit 22 may have RF signal processing capability and data storage capability to record the identity of the trap 20 that sent the RF signal and may include the time and date stamping of the received RF signal. This may show the date and time that the trap 20 was activated. The data relating to the number of activation counts of the sensor 10 in trap 20 may also be included in the transmitted RF signal.

This information may be stored in the non-volatile memory 54 and displayed on the display panel 51 and may be automatically overwritten after a period of time, such as, for example, two weeks. The duration of time that the information stored in the non-volatile memory 54 may be dependent on the capacity of the non-volatile memory 54. The larger the capacity of the non-volatile memory 54, the longer the information can be stored without being overwritten. The trap 20 and the fixed receiving unit 22 may be positioned at a distance less than the lower limit of the transmission range of the RF transceiver unit 12 on the RF device 8 on a trap 20 and the RF transceiver 52 of the fixed receiving unit 22. The microcontroller 58 and the control panel 53 may be used to control the operation of the fixed receiving unit 22. The telecommunications transmitter 56 may be used to transmit information using either wired or wireless means to a central station 26. Information may also be transmitted via direct connection using wires to the synchronisation port 55. The control panel 53 may facilitate the entering of information like a Personal Identification Number (PIN) to access the status of the traps 20. The data relating to the number of counts encountered by a trap 20 over a period of time, such as for example, three days, a week or a fortnight may be re-set without physically pressing the re-set button 7 on the RF device 8 on a trap 20. Resetting the RF device 8 may also be done via wired or wireless (remote) means.

The mobile receiving unit 24 can also be represented in FIG. 3. Examples of the device can be seen in FIG. 7. It may include a display panel 60, a RF transceiver 62, a control panel 64, a synchronisation port 66, a microcontroller 68, a power source 70, non-volatile memory 72 and a telecommunications transmitter 74. The mobile receiving unit 24 may have a power source 70 that may be powered by solar energy or an independent power supply such as a battery. The mobile receiving unit 24 may have RF signal processing capability and data storage capability to record the identity of the trap 20 that sent the RF signal and may include the time and date stamping of the received RF signal. This may show the date and time that the trap 20 was activated. The data relating to the number of activation counts of the sensor 10 in trap 20 may also be included in the transmitted RF signal.

This information may be stored in the non-volatile memory 72 and may be automatically overwritten after a period of time, such as, for example, two weeks. The duration of time that the information stored in the non-volatile memory 54 may be dependent on the capacity of the non-volatile memory. The larger the capacity, the longer the information can be stored without being overwritten. The trap 20 and a user of the mobile receiving unit 24 may be positioned at a distance less than the lower limit of the transmission range of the RF transceiver unit 12 on the RF device 8 of trap 20 and the RF transceiver 62 of the mobile receiving unit 24. The microcontroller 68 may be used to control the operation of the mobile receiving unit 22. The telecommunications transmitter 56 may be used to transmit information using either wired or wireless means to a central station 26.

Information may be transmitted via direct connection using wires to the synchronisation port 66. The display panel 60 may be a liquid crystal display (LCD) or a thin film transistor (TFT) display showing the status of traps 20 after interaction between either the fixed receiving unit 22 or the RF device 8 on the trap 20. The display panel 60 may display any or all of the following: status of traps 20 in a particular locale, date/time of activation of traps 20, number of counts of each trap 20, map of a locale denoting the positions of each trap 20, and so forth. The map display in the display panel 60 may be colour coded, where icons of a particular colour denote whether a trap 20 has been activated or not.

The control panel 64 may facilitate the entering of information like a Personal Identification Number (PIN) to access the status of either the fixed receiving unit 22 or the traps 20. The control panel 64 may be used as a phone keypad should the mobile receiving unit 24 have a phone function incorporated in it. The synchronisation port 66 may be used to download data from the mobile receiving unit 24 at the central station 26 for further analysis and/or archiving. The control panel 64 on the mobile receiving unit 24 may be used to key in a Personal Identification Number (PIN) unique to a location where the traps 20 are employed before data can be downloaded to the mobile receiving unit 24. This prevents anyone with any RF transmitter/receiving unit from being able to make use of the traps 20 laid down by an existing pest control company. This protects the investment made on the apparatus and infrastructure by the incumbent pest control company.

The user of the mobile receiving unit 24 need only be positioned at an easily accessible location, such as for example, a lift lobby, a corridor, a stair well and so forth. The mobile receiving unit 24 may then interrogate the fixed receiving unit 22 to obtain the status and identity of all traps 20 linked to the fixed receiving unit 22. The locations of the traps 20 may be stored in the non-volatile memory 72 of the mobile receiving unit 24 whereby the status and location of activated traps may be obtained by comparing with pre-programmed data in the mobile receiving unit 24. Alternatively, the user would be able to refer to a trap deployment chart to determine the location of the activated traps 20. In this way, a user may be able to use a mobile receiving unit 24 to interrogate a fixed receiving unit 22 and thereby determine the status of all traps 20 linked to a fixed receiving unit 22. Consequently, only the activated traps 20 will be attended to and subsequently re-set by clearing or replacing the animal containment unit 1 and depressing the re-set button 7 on the trap 20. Resetting the RF device 8 may also be done via wired or wireless (remote) means.

A user may use a mobile receiving unit 24 to interact directly with the RF device 8 on the traps 20 and obtain the status, identity and activation count of traps 20 on a particular level of a building. The user of the mobile unit 24 need only be positioned at a convenient location, such as for example, a lift lobby, a corridor, a stair well and so forth. The location, date/time of activation and activation count of traps 20 may be included in the RF signal sent from the RF device 8 on trap 20 to the mobile receiving unit 24. There may be a plurality of signals being transmitted from RF device 8 on the trap 20. The information stored in the non-volatile memory 72 of the mobile receiving unit 24 after interaction with the fixed receiving unit 22 may then be transmitted by the telecommunications transmitter 56 to a central station 26 for real-time analysis of any pest/infestation problem and data storage (archiving).

The fixed receiving unit 22 and the trap 20 may be positioned at a certain distance from each other, such as, for example, 10 m, 20 m, 50 m, or 100 m. The optimal distance is 50 m. A plurality of traps 20 may be linked to one fixed receiving unit 22. Preferably, there is a fixed receiving unit 22 for either a given number of traps 20 (eg. 10 traps) or for a given area (eg. level of a building, or an area of a pre-determined size such as, for example, less than one hectare). The transmission range of the RF signals used should preferably not extend beyond 100 m, as the signals may interfere with many devices used in the world today such as remote controls for electronic devices. The accuracy of the readings of the fixed receiving unit 22 may also be adversely affected due to extraneous signals from the RF devices 8 on the traps 20 in different buildings or locales that are actually linked to a different fixed receiving unit 22. The information stored in the non-volatile memory 54 of the fixed receiving unit 22 may then be transmitted by the telecommunications transmitter 56 to the central station 26 for real-time analysis of any pest/infestation problem and data storage and archiving.

The fixed receiving unit 22 may be positioned at a particular location. A fixed receiving unit 22 may also be employed in buildings whereby a user may use a mobile receiving unit 24 to interact with the RF transceiver 52 of the fixed receiving station 22 and obtain the status, identity and activation count of traps 20 on a particular level of a building. The location, date/time of activation and activation count of traps 20 may be included in the RF signal sent to the fixed receiving unit 22. There may be a plurality of signals being transmitted from the RF device 8 in the trap 20. The information stored in the non-volatile memory 72 of the mobile receiving unit 24 after interaction with the RF transceiver 52 of the fixed receiving unit 22 may then be transmitted by the telecommunications transmitter 56 to a central station 26 for real-time analysis of any pest/infestation problem and data storage(archiving).

The fixed receiving unit 22 may be mobile such that it may be positioned at a particular location where it is turned on to receive any transmitted signals from RF devices 8 on activated traps 20. The fixed receiving unit 22 then stores information in the non-volatile memory 54 regarding the activated traps 20. The information may then either be accessed by mobile receiving unit 24 or it may be transmitted to the central station 26 for other purposes, such as, for example, analysing the severity of the infestation problem. Downloading may be by use of RF signals to the central station 26, or by use of a telecommunications network (wireless or wired), or the like. The data from several fixed receiving stations 22 may be transmitted to a designated fixed receiving station 22 for the data to be consolidated and/or collated before transmission back to the central station 26.

The checking of traps 20 should be performed at regular intervals such that the trapped animals are cleared before decomposition of the carcasses set in. An appropriate interval may be two days. This may prevent the undesirable spreading of parasites and maggots that emanate from decomposing carcasses. Employing the traps 20 and using either the fixed receiving unit 22 or mobile receiving unit 24 eases the task of checking every trap 20 to determine its status. The employment of the system may result in an efficient method to check a large number of traps 20 in a building that using less working hours, less labour and consequently, less manpower to control the pest population in a building. As such, the amount of money payable for workers' wages and for workmen's compensation due to injuries caused by accessing hard-to-reach places may also be subsequently reduced.

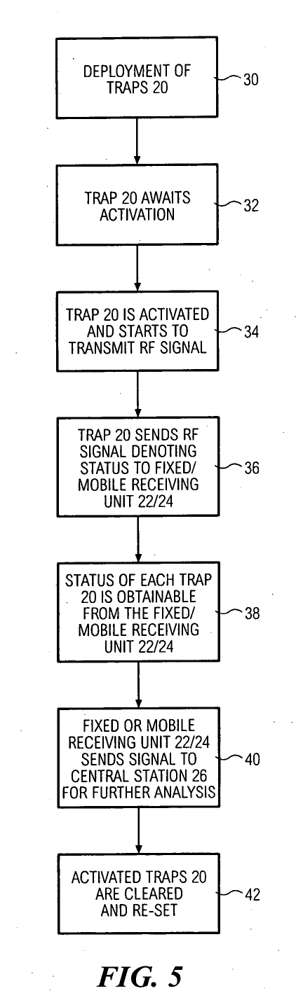

FIG. 5 shows the sequence of steps in the method of employing the present invention. The traps 20 of the trapping system are initially deployed in regions where the animals/insects are most likely to populate/infest 30. The traps 20 await activation 32 which occur when the sensor 10 in the trap 20 is triggered by an animal/insect moving into the trap 20 and subsequently getting trapped in the containment unit 1 of the trap 20. In such a situation, the trap 20 may be considered to be activated. When the trap 20 is activated 34, the RF tranceiver 12 in the RF device 8 closely associated with trap 20 may transmit an RF signal 36 to either a fixed receiving unit 22 or a mobile receiving unit 24. The RF device 8 may also transmit signals only after being “awoken” through interaction with the mobile receiving unit 24. Preferably, the transceiver 12 also receives an acknowledgement of receipt sent by either a fixed receiving unit 22 or a mobile receiving unit 24. If no acknowledgement of receipt is received, trap 20 may resend the RF signal at regular intervals until the acknowledgement of receipt is received. The transmitted RF signal is received by either a fixed receiving unit 22 or a mobile receiving unit 24 and the signal is processed and recorded.

When a user comes on-site in close proximity to the trap 20, the user will use their mobile receiving unit 24 to interact with the RF device 8 on the trap 20 to determine the status of all traps 20. The status of each trap 20 may become obtainable after processing the signal 38. The status and identity of each trap 20 is then determined from pre-programmed data in the mobile receiving unit 24 and displayed on the display panel 60 of mobile receiving unit 24, by audio signal, by both, otherwise as desired. Data relating to the status of trap 20 is forwarded to the central station 26 from either the fixed receiving unit 22 or the mobile receiving unit 24. The data may be transmitted either via wireless or wired means 40. Subsequently, the activated traps are either replaced or cleared and re-set to ready mode 42. The transmitting range of the transmitter 12 in traps 20 is preferably quite limited so as to not interfere with other traps 20 or fixed receiving units 22. This is similarly so for mobile receiving unit 24 and fixed receiving units 22. The transmission range should be greater than their physical separation.

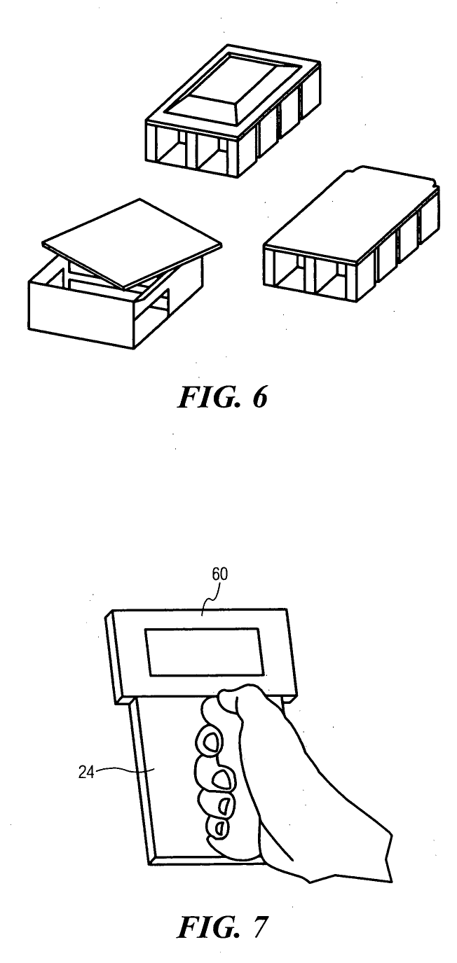

FIG. 6 shows different type of traps that may be adaptable to be employed in the present invention. The traps employed may be for use against animals and insects, such as, for example, mice, rats, cockroaches, lizards, termites and the like.

In another embodiment of the present invention, the trapping system may be used in the field of science to study species of animals. The trap 20 may be employed in the natural habitats of the animals being studied and the captured animals may be electronically tagged and then subsequently released into the wild. The trap 20 employed may be nonthreatening to the lives of such animals under observation.

Whilst there has been described in the foregoing description preferred embodiments of the present invention, it will be understood by those skilled in the technology concerned that many variations or modifications may be made to details of design or construction without departing from the present invention.

The present invention extends to all features disclosed either individually, or in all possible permutations and combinations.

1. A trap for trapping animals including:
at least one radio frequency (RF) device closely associated with the trap for the recording of activation data of the trap;
at least one animal containment unit incorporated with the trap; and
at least one sensor for detecting activation of the trap and passing an activation signal to the RF device;
wherein the RF device is for transmitting RF signals in a localised area to at least one receiving unit for enabling the real-time determination of a status of the trap.

2. A trap for trapping animals as claimed claim 1, wherein the RF device includes:
at least one power source;
at least one RF transceiver;
non-volatile memory;
at least one microcontroller; and
at least one re-setting means to erase information stored in the non-volatile memory.

3. A trap for trapping animals as claimed in claim 1, wherein the receiving unit is mobile.

4. A trap for trapping animals as claimed in claim 3, wherein the mobile receiving unit includes:
at least one power source;
at least one display panel;
at least one RF transceiver;
non-volatile memory;
at least one microcontroller;
at least one control panel to control the collection and transmittal of data relating to the status of the at least one trap;
at least one telecommunications transmitter to transmit information to a central station; and
at least one synchronisation port to enable the downloading of information to the central station.

5. A trap for trapping animals as claimed in claim 1, wherein the receiving unit is fixed.

6. A trap for trapping animals as claimed in claim 5, wherein the fixed receiving unit includes:
at least one power source;
at least one display panel;
at least one RF transceiver;
non-volatile memory;
at least one microcontroller;
at least one control panel to control the collection and transmittal of data relating to the status of the at least one trap;
at least one telecommunications transmitter to transmit information to a central station; and
at least one synchronisation port to enable the downloading of information to the central station;
wherein the fixed receiving unit is located at a particular location.

7. A trap for trapping animals as claimed in claim 5, wherein the fixed receiving unit transmits signals via RF after interacting with a mobile receiving unit which subsequently displays the status and location of activated traps by comparing with pre-programmed data in the mobile receiving unit.

8. A trap for trapping animals as claimed in claim 4, wherein the mobile receiving unit may be connected to the central station to download data via a wireless telecommunication transmission.

9. A trap for trapping animals as claimed in claim 7, wherein the mobile receiving unit may be connected to the central station to download data via a synchronisation port.

10. A trap for trapping animals as claimed in claim 6, wherein the fixed receiving unit may be connected to the central station to download data via a wireless telecommunication transmission.

11. A trap for trapping animals as claimed in claim 6, wherein the fixed receiving unit may be connected to the central station to download data via a wired telecommunication transmission.

12. A trap for trapping animals as claimed in claim 6, wherein the fixed receiving unit may be connected to the central station to download data via a synchronisation port.

13. A trap for trapping animals as claimed in claim 1, wherein the transmission range of the RF signals lies between 0-100 m.

14. A trap for trapping animals as claimed in claim 13, wherein the range of transmission of the RF signals lies between 20-70 m.

15. A trap for trapping animals as claimed in claim 14, wherein the range of transmission of the RF signals is 50 m.

16. A trap for trapping animals as claimed in claims 1, wherein the trap requires the keying in of a Personal Identification Number (PIN) into the receiving unit to be operable.

17. A method for determining the status of at least one trap for animals at a regular time interval using the trap for trapping animals as claimed in claim 1.

18. A method for determining the status of at least one trap for animals as claimed in claim 17, wherein the regular time interval is two days.

19. A method as claimed in claim 17, wherein the status of at least one trap includes the occurance of animal incidence.

20. A trap as claimed in claim 1, wherein the trap is used to determine the occurance of animal incidence.

21. A trap as claimed in claim 1, wherein the status of the trap includes the occurance of animal incidence.

22. A trap as claimed in claim 1, wherein the signals are transmitted intermittently.

23. A trap as claimed in claim 1, wherein the signals are transmitted continuously.

24. A trap as claimed in claim 1, wherein the signals are transmitted only after interaction with the receiving unit.

25. A trap as claimed in claim 1, wherein the localised area can be chosen from a group consisting of: a building, a cluster of buildings, a plot of land less than one hectare.

26. A trap for trapping animals as claimed in claim 7, wherein the mobile receiving unit may be connected to the central station to download data via a wireless telecommunication transmission.
